(19) United States
(12) Patent Application Publication
(10) Pub. No.: US 2006/0139684 A1
(43) Pub. Date: Jun. 29, 2006

(54) Sharing information

(76) Inventor: Mikko Nurmi, Tampere (FI)

Correspondence Address: Hollingsworth & Funk, LLC, Suite 125, 8009 34th Avenue South, Minneapolis, MN, 55425, US

(21) Appl. No.: 11/312,328

(22) Filed: Dec. 20, 2005

(30) Foreign Application Priority Data
Dec. 29, 2004 (FI) 20045510

(51) Int. Cl. G06F 3/12

(52) U.S. Cl. 358/1.15

(57) ABSTRACT

In order to facilitate information sharing in a user friendly way, both file transmission and call establishment are triggered in response to a user command given in a file handling application.

### FIELD OF THE INVENTION

The invention relates to calling based on a file, and more particularly to transmitting files and calling, preferably simultaneously.

### BACKGROUND OF THE INVENTION

The evolvement of communication technology and user terminals has enabled versatile communication possibilities. Modem networks, both cellular and fixed ones, enable both speech communication and data communication. To facilitate usage of both types of communication, it is more and more common that web cameras and microphones are connected to personal computers allowing speech communication and image change over a fixed or wireless network. So-called smart phones containing office applications, such as email and word processing applications, and other features have been developed for a wireless network, the smart phones providing similar features for users as personal computers, thus allowing also data communication and versatile file handling.

Alongside these features, also different software applications for versatile communication, such as calling, file sharing or chatting, have evolved. An example of such an application is Microsoft Netmeeting that provides multi-point data conferencing, text chat, whiteboard, and file transfer, as well as point-to-point audio and video and a web-phone enabling face-to-face conversations. Also several so called utility programs, such as word processing programs and spreadsheet programs, contain possibilities to send an open file to one or more recipients as an email such or an attachment to an email.

One of the disadvantages associated with the above applications is that whilst they provide calls and file transmission, they provide them as separate functions. For example, when a caller wants to shortly discuss a document received a week ago with a colleague, he calls the colleague, but there is a strong possibility that the colleague does not remember the content of the document.

One solution is to send the document first and then make the call. This involves, however, two separate functions requiring two separate connections and user actions: a data connection for sending the document and another connection for discussions. This takes some time and is susceptible to errors, for example the document may accidentally be sent to a person other than the one to whom the call is established.

### BRIEF DESCRIPTION OF THE INVENTION

An object of the present invention is thus to provide a method and an apparatus for implementing the method so as to alleviate the above disadvantage. The object of the invention is achieved by a method, a user terminal and a software product which are characterized by what is stated in the independent claims. The preferred embodiments of the invention are disclosed in the dependent claims.

The invention is based on realizing the problem and solving it by triggering call establishment and file sending in response to a user command. A call as used herein refers to any speech communication including circuit switched communication, packet switched communication, voice over Internet (VoIP) communication, video calls, multi-party conferences, other session-based communication, etc.

An advantage of the invention is that it improves usability by reducing steps the user has to perform; a user has to give only one command for making a call and sending a document. Thus, the invention provides an efficient way to establish a call and send a file associated with call-related subject matter. This advantage is particularly significant when there is a need to shortly discuss file content or part of the file content by phone.

### BRIEF DESCRIPTION OF THE DRAWINGS

In the following the invention will be described in greater detail by means of preferred embodiments with reference to the accompanying drawings, in which

FIG. 1 illustrates a general communications system architecture providing file transmission and calls between users;

FIG. 2 is a flow diagram illustrating functionality according an embodiment;

FIG. 3 illustrates signalling according another embodiment; and

FIG. 4 is a flow diagram illustrating functionality according to a further embodiment.

### DETAILED DESCRIPTION OF SOME EMBODIMENTS

The present invention is applicable to any communications system or any combination of different communications systems that is accessible by user terminals and provides file sharing and calls between user terminals. The communications system may be a fixed communications system or a wireless communications system or a communications system utilizing both fixed networks and wireless networks. The applications used, the specifications of communications systems and terminals, especially in wireless communications, develop rapidly. Such development may require extra changes to the invention. Therefore, all words and expressions should be interpreted broadly and they are intended to illustrate, not restrict the invention.

In the following, the present invention is described using a very simplified system environment. It should be appreciated that the communications system and the transmission protocol used are not relevant to the actual invention. Therefore, they need not to be discussed in more detail here. The present invention primarily relates to triggering call establishment and file transmission in response to a user command.

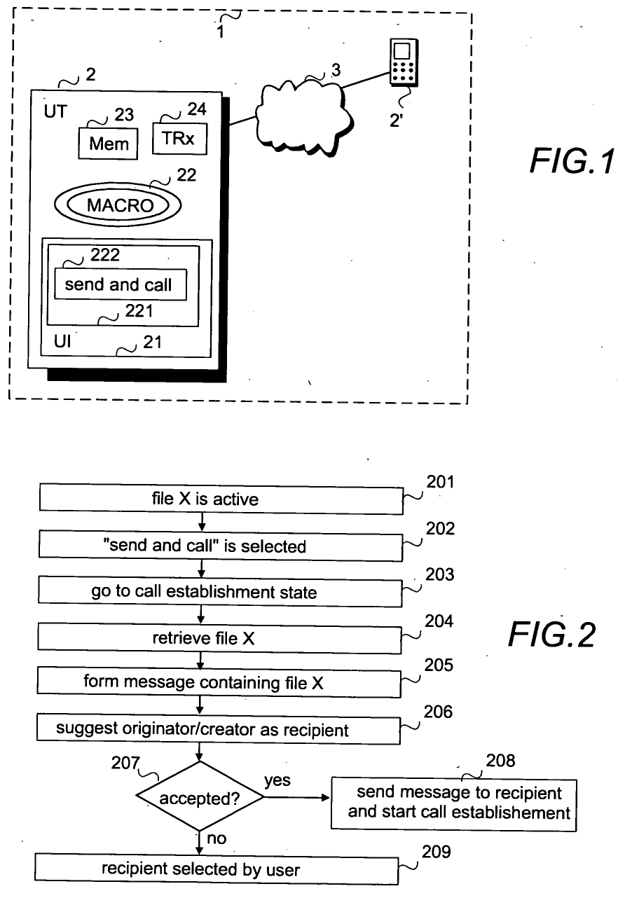

FIG. 1 is a very simplified system architecture, only showing a communications system 1, two user terminals UT 2, 2′ and a network 3. It is apparent to a person skilled in the art that the system(s) comprise(s) also other devices, system entities, functions and structures that need not be described in detail herein.

A user terminal 2, 2′ is a piece of equipment or a device that allows a user to interact with a communications system directly or via a computer system, that is, it presents information to the user and allows the user to input information, i.e. the user terminal is a termination point of particular communication. In other words, the user terminal 2, 2′ may be any node or a host which provides speech communication, data transfer and file viewing and can communicate with a network of the system, over the access network (not shown in FIG. 1) if such an access network exists. The user terminal 2, 2′ may be a non-mobile apparatus, such as a personal computer PC with loudspeaker(s) and a microphone, connected to the network 3 wirelessly or via a fixed connection. The user terminal 2, 2′ may also be a wireless mobile terminal supporting messaging and voice call, a multi-service terminal that serves as a service platform and supports the loading and execution of different functions related to services, or a laptop PC with loudspeaker(s) and a microphone, the laptop PC being connectable to the network (via a possible access network), a convergence device, such as a home entertainment system, connectable to the network (via a possible access network), etc.

The user terminal 2 comprises at least one user interface 21 via which the user can interact with different applications and other users, one or more file handling applications 22, memory Mem 23 (or it is arranged to have access to memory) for storing files and a transceiver TRx 23 for sending and receiving communications. The term “file” covers here all types of contents sendable from a user terminal and viewable and/or hearable via the user interface, the content being stored as a single file or as a file containing one or more subfiles, such as a folder or an email having attachments. Thus, a file may be a text document, graphics, image, short message, song, video clip, email, power point representation, spreadsheet, multimedia message, photograph etc., i.e. anything that can be formed by a file handling application or for a file handling application.

The file handling application 22 is a software application that may run partly in the background on a user terminal. The file handling application covers here all applications with which a sendable file may be opened/handled. The file handling application 22 may be shipped with the user terminal or it may be a downloadable plug-in to the user terminal or otherwise later added to the user terminal. Examples of file handling applications include word processing applications, viewing applications, email-applications, audio applications, applications providing messaging, such as multimedia messages or short messages, other office applications etc.

In the example shown in FIG. 1, a file handling application 22 has been activated and a selection list 221 is shown to the user via the user interface 21, the selection list containing an alternative “send and call” 222, the selection of which triggers functionality according to an embodiment of the invention, examples of which will be described below. However, the invention is not restricted to selection lists containing such an alternative or a corresponding alternative, such as a “rich phone call” or “enhanced call”. Instead of a selection list, the user terminal may be configured to perform the “send and call” functionality in response to a user pressing (a) call button(s) of the user terminal while he has a file open/active, for example. The functionality may be achieved by updating a corresponding file handling application, by one or more applets or by defining one or more macros, the functionality combining these two separate functions.

FIG. 2 is a flow chart illustrating functionality of a user terminal according to an embodiment of the invention. In the example of FIG. 2 it is assumed that the user has a file X open and active (step 201). The file X may be a text document, an email or a short message which the user is currently reading, for example. Then the user selects a “send and call” alternative from a selection list in a file handling application. In other words, the user terminal receives, in step 202, a “send and call” selection. In response to the selection, the user terminal triggers the call establishment and file transmission. In other words, the user terminal goes, in step 203, to a call establishment state and retrieves, in step 204, the file X. The user terminal knows which file to retrieve on the basis of which file was active when the selection was made. This embodiment has the further advantage that the file to be sent is the file meant to be sent, whereas when browsing is used, a wrong file may be accidentally selected. Then the user terminal forms, in step 205, a message containing the file X. The message may be a WAP Push SL message or an MIME email message, for example. The WAP (Wireless Application Protocol) is a protocol specification for a communications protocol and an application environment. The WAP Push SL (Service Load) messages can be used to download content to a user terminal in the background without user intervention. If required, further information can be found on the home page of WAP Forum working on the WAP specification at http://www.wapforum.org. The MIME stands for Multipurpose Internet Mail Extensions, which enables email applications supporting the MIME to send different types of files over the Internet and to launch an attached file in response to receiving the MIME email message. However, it bears no significance for the invention how the file X is transmitted; the above are purely examples.

In the embodiment described in FIG. 2, the user terminal suggests, in step 206, to the user that the recipient may be the originator (e.g. when the file X is an email message) or the creator (e.g. when the file X is a Word document), if the information is available. It may even suggest both of them, if this information is available.

If the user accepts (step 207) the suggested recipient(s), the message containing the file X is sent, in step 208, to the recipient and call establishment to the recipient is started in step 208.

If the user does not accept the suggested recipient(s), the user selects recipient(s) from a contact list/distribution list/address book or gives the recipient(s) manually via the user interface, i.e. by any conventional manner as well as by any future manner. It is apparent to one skilled in the art that how a recipient is selected is irrelevant for the invention. When the user terminal receives, in step 209, the user's selection for recipient(s), the message containing the file X is sent, in step 208, to the recipient and call establishment to the recipient is started in step 208.

In another embodiment of the invention, the user always gives the recipient(s). In other words, they are not suggested by the user terminal, i.e. steps 206 and 206 are skipped and step 209 is performed directly after step 205.

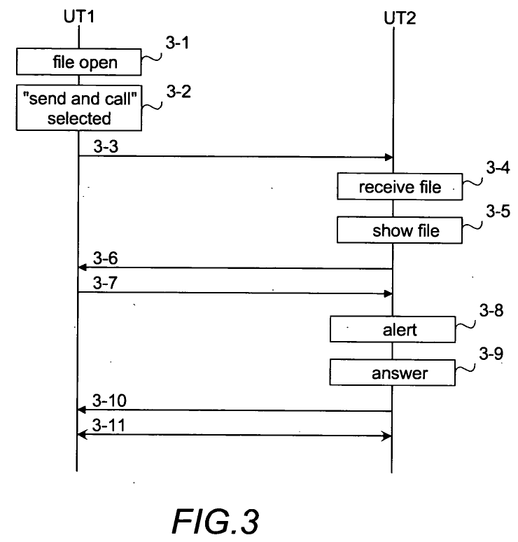

FIG. 3 illustrates signalling according to another embodiment of the invention. FIG. 3 starts in a situation where a file has been opened, at point 3-1, in the user terminal and then “send and call” is selected, at point 3-2, in a file handling application by the user, and thus file transmission and call establishment are triggered.

In response to the selection, the user terminal UT1 sends a message 3-3 containing the file to a recipient, i.e. a user terminal UT2. The recipient may be given as illustrated above. The message may be a WAP Push SL message, for example. The user terminal UT 2 receives the file at point 3-4, shows at point 3-5 the file to the user via a user interface, and sends an acknowledgement message 3-6 to the user terminal UT1.

While the message sending is being performed in the background, the user terminal UT1 has also started call establishment and sends a call set-up message 3-7 to the user terminal UT2. In other words, this happens simultaneously with the message sending. The call set-up message may be a call-set up message according to GSM (Global System for Mobile communications), for example. In response to the message 3-7, the user terminal UT2 alerts at point 3-8. When the call is answered at point 3-9 an acknowledgement for call establishment is sent in a message 3-10 to the user terminal UT1. After that a discussion on the file may be carried out in messages 3-11.

The structure, protocol used, network used for transmitting the message 3-7, are totally independent of those of the message 3-3. Furthermore, messaging and call set-up details are irrelevant for the invention.

In the above embodiment, the message would still be shown to the user of the UT2 even if the UT2 did not answer. This would have a further advantage that the user would know what subject matter the unanswered call related to.

In another embodiment of the invention, the call set-up is started only after the message 3-6 acknowledging the reception of the file is received. In further embodiments of the invention, the call set-up is started after a certain time (a preset or given by a user) has lapsed either from the sending of the message 3-3 or from the reception of the message 3-6. These alternatives have the further advantage that the recipient will have some time to familiarize himself with the content of the sent file.

In still another embodiment of the invention, the file transmission, i.e. sending the message 3-3, is started only after the message 3-10 acknowledging that the call was answered is received. This has the further advantage that the caller may give some information relating to the file before the file is received. In an embodiment requesting confirmation before sending a file, the caller may even cancel the file transmission after asking the recipient whether or not the recipient needs the file for conversation.

In yet another embodiment of the invention, the message 3-3 contains an indication indicating that the attached file or the content of the message has to be launched. In the embodiment, the user terminal UT1 is arranged to add such an indication to the message 3-3 and the user terminal UT2 is arranged to be responsive to said indication in the received message, and to launch the attached file or the message content.

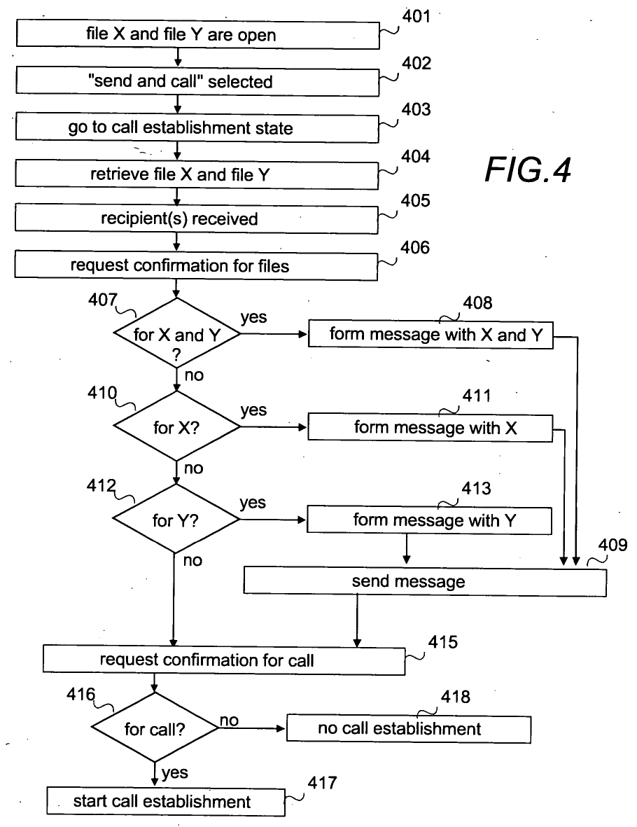

FIG. 4 is a flow chart illustrating functionality of a user terminal according to an embodiment of the invention. In the example of FIG. 4 it is assumed that the user has files X and Y open and active (step 401). The files may be of different type; the file X may be a text document and file Y a picture, or the file X may be an email having file Y as an attachment, or the file X may be an email and file Y a text document, for example. Then the user selects the “send and call” alternative from a selection list in a file handling application. In other words, the user terminal receives, in step 402, a “send and call” selection. In response to the selection, the user terminal triggers the call establishment and file transmission. In other words, the user terminal goes, in step 403, to a call establishment state and retrieves, in step 404, the files X and Y. Meanwhile the recipient(s) is/are selected and the user terminal receives, in step 405, the recipients. In this embodiment, the user terminal requests, in step 406, after the files have been retrieved, confirmation that the retrieved files are sent. If the confirmation is received for both files (step 407), the user terminal forms, in step 408, a message containing the files X and Y and sends, in step 409, the message to the recipient. If the confirmation is received for file X (step 410), the user terminal forms, in step 411, a message containing the file X and sends, in step 409, the message to the recipient. If the confirmation is received for file Y (step 412), the user terminal forms, in step 413, a message containing the file Y and sends, in step 409, the message to the recipient. If none of the files is confirmed, no messages are sent. In another embodiment, the user terminal may provide a file browsing option with this confirmation procedure relating to file transmission.

The user terminal also requests, in step 414, confirmation that the call is established. If the call establishment is confirmed in step 415, the call establishment is started in step 416. Otherwise no call is established (step 417).

The above-described confirmation procedures provide the user with an option to cancel the “send and call” selection.

The steps, points and signalling messages shown in FIGS. 2, 3 and 4 are not in the absolute chronological order and some of the steps/points may be performed simultaneously or differing from the given order. Other functions can also be executed between the steps/points or within the steps/points, such as those relating to confirming the file selection, file sending and/or calling. Some of the steps/points or part of the steps/points can also be left out, for example steps 206 and 207 relating to the user terminal suggesting recipients or step 205 in a situation where the file is already a message ready to be sent. The signalling messages are only exemplary and may even comprise several separate messages for transmitting the same information. In addition, the messages may also contain other information. The messages and steps/points can also be freely combined or divided into several parts. Furthermore, the names, types and/or contents of the messages, as well as the protocols used, may differ from the above-mentioned ones.

Although in the above the invention is disclosed assuming that the communication, i.e. file transmission and calls, is one-to-one communication, it is obvious for one skilled in the art that the communication may as well be one-to-many communication.

Although in the above the invention is disclosed assuming that the “send and call” functionality is implemented as part of an application used when the file is viewed, it is apparent for one skilled in the art that the invention may be implemented as a separate application. Such a separate application is still a file handling application and may be based on browsing one or more files and sending the browsed file(s) while calling.

The embodiments presented above or parts of them can be combined to produce preferred embodiments of the invention.

The user terminals and other corresponding devices implementing the functionality of the present invention comprise not only prior art means but also means for triggering call set-up and file transmission in the manner described above. Present user terminals comprise processors and memory that can be utilized in the functions according to the invention. All modifications and configurations required for implementing the invention may be performed as routines, which may be implemented as added or updated software routines, application circuits (ASIC) and/or programmable circuits. Program(s)/applet(s)/macro(s)/software routines can be stored in any terminal-readable data storage medium.

It will be obvious to a person skilled in the art that, as the technology advances, the inventive concept can be implemented in various ways. The invention and its embodiments are not limited to the examples described above but may vary within the scope of the claims.

1. A method of sharing information between at least two users, the method comprising triggering both file transmission and call establishment in response to a user command received in a file handling application.

2. A method as claimed in claim 1, wherein the triggered file transmission comprises retrieving an open file and sending the open file.

3. A method as claimed in claim 2, wherein the triggered file transmission further comprises forming a message containing the retrieved file.

4. A method as claimed in claim 1, further comprising performing the file transmission and call establishment simultaneously.

5. A method as claimed in claim 1, further comprising starting the call establishment in response to receiving an acknowledgement that the file transmission succeeded.

6. A method as claimed in claim 1, further comprising starting the call establishment after a certain time has lapsed from a reception of an acknowledgement that the file transmission succeeded.

7. A method as claimed in claim 1, further comprising starting the call establishment after a certain time has lapsed from the file transmission.

8. A method as claimed in claim 1, further comprising starting the file transmission after a certain time has lapsed from the call establishment.

9. A user terminal containing a user interface and a file handling application, wherein the user terminal is configured to trigger both call establishment and file transmission in response to a user command given in the file handling application via the user interface.

10. A user terminal as claimed in claim 9, wherein the file handling application is an email application and the file is an email or an attachment to an email.

11. A user terminal as claimed in claim 9, wherein the file handling application is a messaging application and the file is a received message.

12. A user terminal as claimed in claim 9, wherein the file handling application is an office application and the file is an office application file.

13. A software program product embodied in a user terminal readable medium, said computer program product comprising program instructions, wherein execution of said program instructions causes the user terminal to trigger both file transmission and call establishment in response to a user command received in a file handling application.

14. A software program product as claimed in claim 13, wherein the execution further causes, as part of the triggered file transmission, the user terminal to retrieve an open file and to send the open file.

15. A software program product as claimed in claim 14, wherein the execution further causes, as part of the triggered file transmission, the user terminal to form a message containing the retrieved file.

16. A software program product as claimed in claim 13, wherein the execution further causes the user terminal to perform the file transmission and call establishment simultaneously.

17. A software program product as claimed in claim 13, wherein the execution further causes the user terminal to start the call establishment in response to receiving an acknowledgement that the file transmission succeeded.

18. A software program product as claimed in claim 13, wherein the execution further causes the user terminal to start the call establishment after a certain time has lapsed from a reception of an acknowledgement that the file transmission succeeded.

19. A software program product as claimed in claim 13, wherein the execution further causes the user terminal to start the call establishment after a certain time has lapsed from the file transmission.

20. A software program product as claimed in claim 13, wherein the execution further causes the user terminal to start the file transmission after a certain time has lapsed from the call establishment.
